(19) United States
(12) Patent Application Publication
(10) Pub. No.: US 2019/0039199 A1
(43) Pub. Date: Feb. 7, 2019

(54) Pipeline Weld Finishing System And Process

(71) Applicants: Derek Webb, West Union, WV (US); Steve Smith, West Union, WV (US); Stanley Webb, West Union, WV (US)

(72) Inventors: Derek Webb, West Union, WV (US); Steve Smith, West Union, WV (US); Stanley Webb, West Union, WV (US)

(21) Appl. No.: 15/998,319

(22) Filed: Aug. 6, 2018

Related U.S. Application Data
(60) Provisional application No. 62/541,683, filed on Aug. 5, 2017.

(51) Int. Cl. B24B 5/04; B24B 27/033; B05D 3/12

(52) U.S. Cl. CPC B24B 5/04; B24B 9/04; B05D 3/12; B24B 27/033

(57) ABSTRACT

Various embodiments relate to a blasting ring for blasting a weld on a pipe, including: a ring structure with a first pivot point and a latch, wherein the first pivot point allows the ring structure to open and close around the pipe and the latch is configured to secure the ring to the pipe; a plurality of rollers attached to the ring structure configured to engage the pipe; a cleaner brush attached to the ring structure configured to rotate and engage the weld on the pipe to clean the weld; and a profile brush attached to the ring structure configured to rotate and engage the weld on the pipe to profile the weld. Further, the blasting ring and a heating ring may be used to finish the weld on a pipe.

### BACKGROUND

Sandblasting of pipes in the oil and gas industry has become a hot topic of discussion. The Environmental Protection Agency (EPA) and state Department of Environmental Protection (DEP) agencies are starting to enact stiff sanctions on companies failing to contain the contaminants that result from sandblasting. Other agencies such as Occupational Safety and Health Administration (OSHA) are focusing on the silica used in sandblasting and how the silica comes in contact with the people working on the project.

### SUMMARY

A summary of various exemplary embodiments is presented below. Some simplifications and omissions may be made in the following summary, which is intended to highlight and introduce some aspects of the various exemplary embodiments, but not to limit the scope of the invention. Detailed descriptions of an exemplary embodiment adequate to allow those of ordinary skill in the art to make and use the inventive concepts will follow in later sections.

Various embodiments relate to a blasting ring for blasting a weld on a pipe, including: a ring structure with a first pivot point and a latch, wherein the first pivot point allows the ring structure to open and close around the pipe and the latch is configured to secure the ring to the pipe; a plurality of rollers attached to the ring structure configured to engage the pipe; a cleaner brush attached to the ring structure configured to rotate and engage the weld on the pipe to clean the weld; and a profile brush attached to the ring structure configured to rotate and engage the weld on the pipe to profile the weld.

Further various embodiments relate to a method of finishing a weld on a pipe, including: placing a ring blaster ring around a pipe; rotating the ring blaster ring around the pipe while rotating a cleaner brush and profile brush; removing the ring blaster ring from around the pipe;

placing a heating coil around the pipe; heating the pipe with the heating coil; removing the heating coil from around the pipe; and coating the heated pipe.

### BRIEF DESCRIPTION OF THE DRAWINGS

In order to better understand various exemplary embodiments, reference is made to the accompanying drawings, wherein:

FIGS. 1A-1F illustrate an embodiment of a blaster ring;

FIGS. 2A-2B illustrate another embodiment of a blaster ring;

FIGS. 3A-3B illustrate an embodiment of the vacuum attachment;

FIG. 4 illustrates a weld finishing vehicle;

FIG. 5 illustrates an embodiment of the heating ring; and

FIG. 6 illustrates an embodiment of the coating gun that may be used in the weld finishing system.

### DETAILED DESCRIPTION OF THE INVENTION

The description and drawings illustrate the principles of the invention. It will thus be appreciated that those skilled in the art will be able to devise various arrangements that, although not explicitly described or shown herein, embody the principles of the invention and are included within its scope. Furthermore, all examples recited herein are principally intended expressly to be for pedagogical purposes to aid the reader in understanding the principles of the invention and the concepts contributed by the inventor(s) to furthering the art and are to be construed as being without limitation to such specifically recited examples and conditions. Additionally, the term, “or,” as used herein, refers to a non-exclusive or (i.e., and/or), unless otherwise indicated (e.g., “or else” or “or in the alternative”). Also, the various embodiments described herein are not necessarily mutually exclusive, as some embodiments can be combined with one or more other embodiments to form new embodiments.

The embodiments disclosed below improve three aspects of the pipeline construction process: first, sandblasting is being eliminated entirely; second, torch heating that utilizes open flame and propane is not used in the process; and third, the most effective and least environmentally hazardous type of coatings are being utilized.

Currently the following steps are performed in constructing a pipeline. Once a pipeline has been welded, a sandblasting crew of approximately three to four workers will sandblast the weld. This process takes anywhere from 30-45 minutes and sometimes longer. Once the sandblasting crew is finished, they move on to the next weld.

Next, a worker with a torch and propane tank heats the pipe up to a temperature of approximately 200-250° F. Depending on the size and thickness of the pipe, this can take anywhere from 10-15 minutes. In the winter, it may take up to 25 minutes.

Lastly, once the pipe has been heated, a coating crew of two to three workers applies the coating, usually by hand. Because coating crew applies the coating by hand the coating sometimes gets on the ground below the pipe and all around the crew. This process usually takes up to 15 minutes.

Even after these three steps, most of the time there will be a cleanup crew that has to come after the other crews and clean up the sandblasting contaminants, as well as any coating contaminants that may have been left behind. This clean up may take approximately ten minutes.

All in all, it takes 8 to 10 workers approximately an hour to an hour and a half to blast and coat one joint/weld of pipe. Further, if the sandblasting crews are careless and the cleanup crews fail to get all of the contaminants, the company could be looking at a hefty Notice of Violation from the DEP or EPA.

Now embodiments of a weld finishing system and process will be described that improves upon the current weld finishing systems and methods in use today.

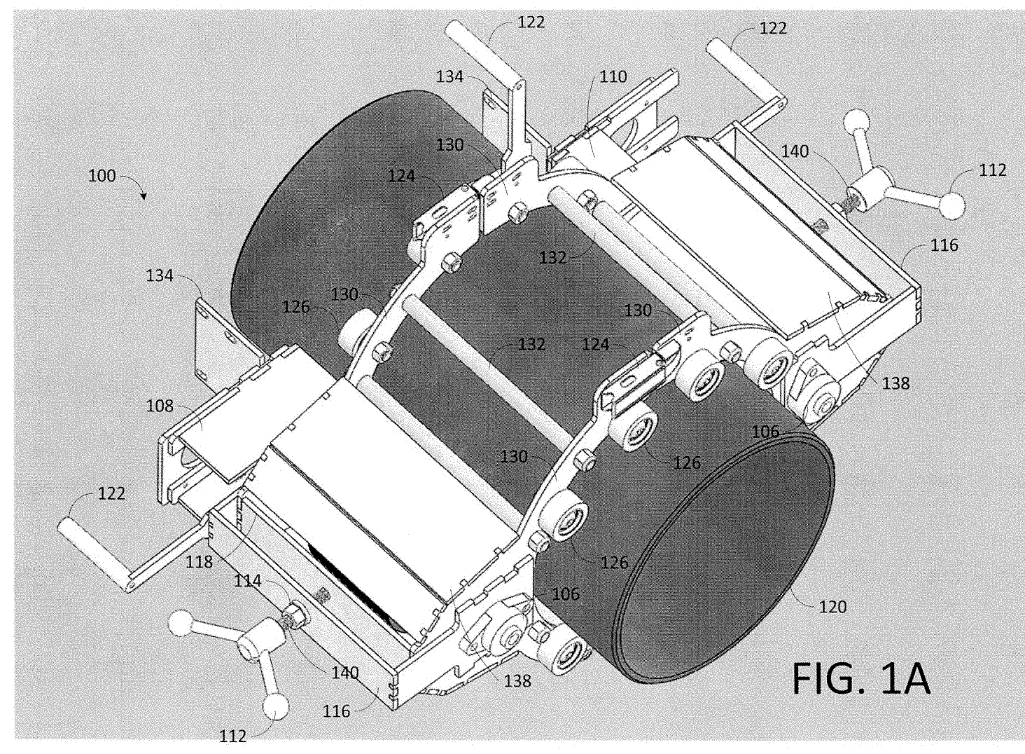

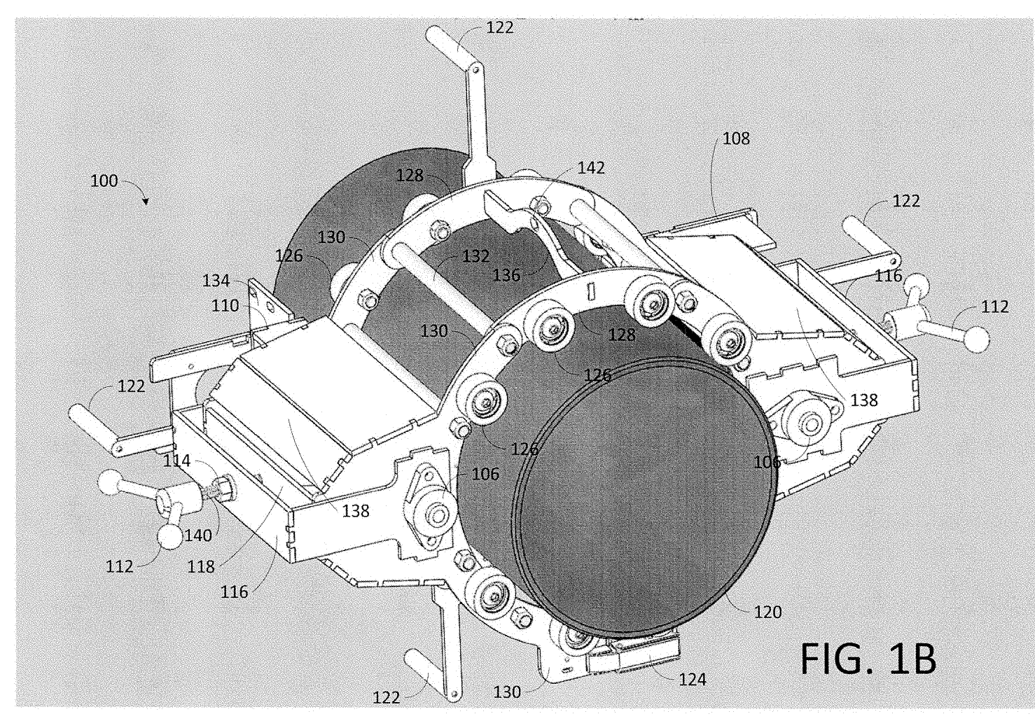

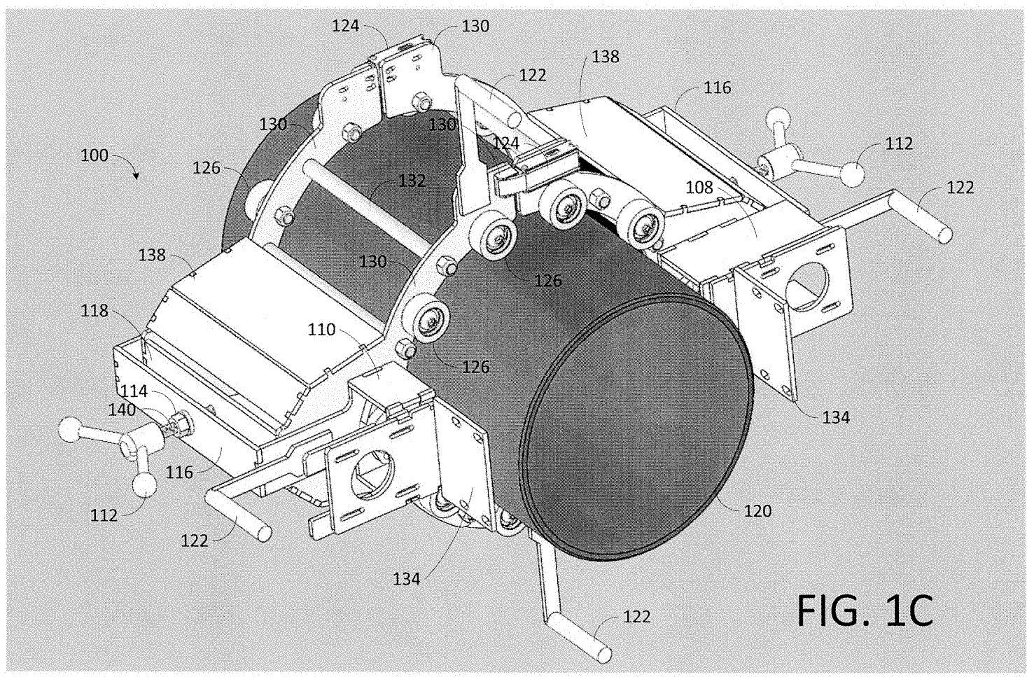

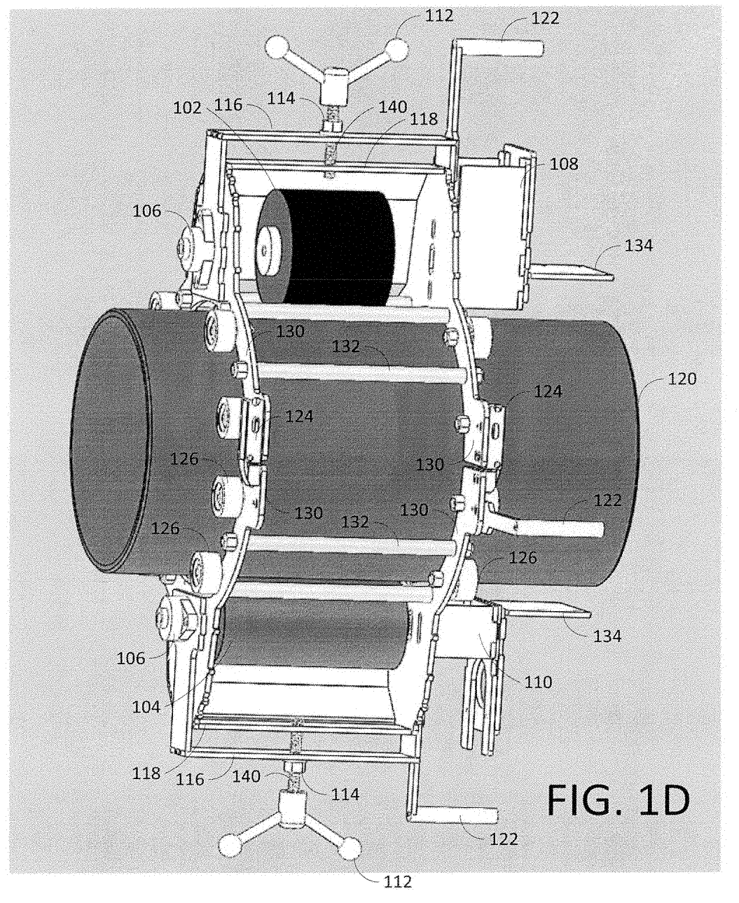

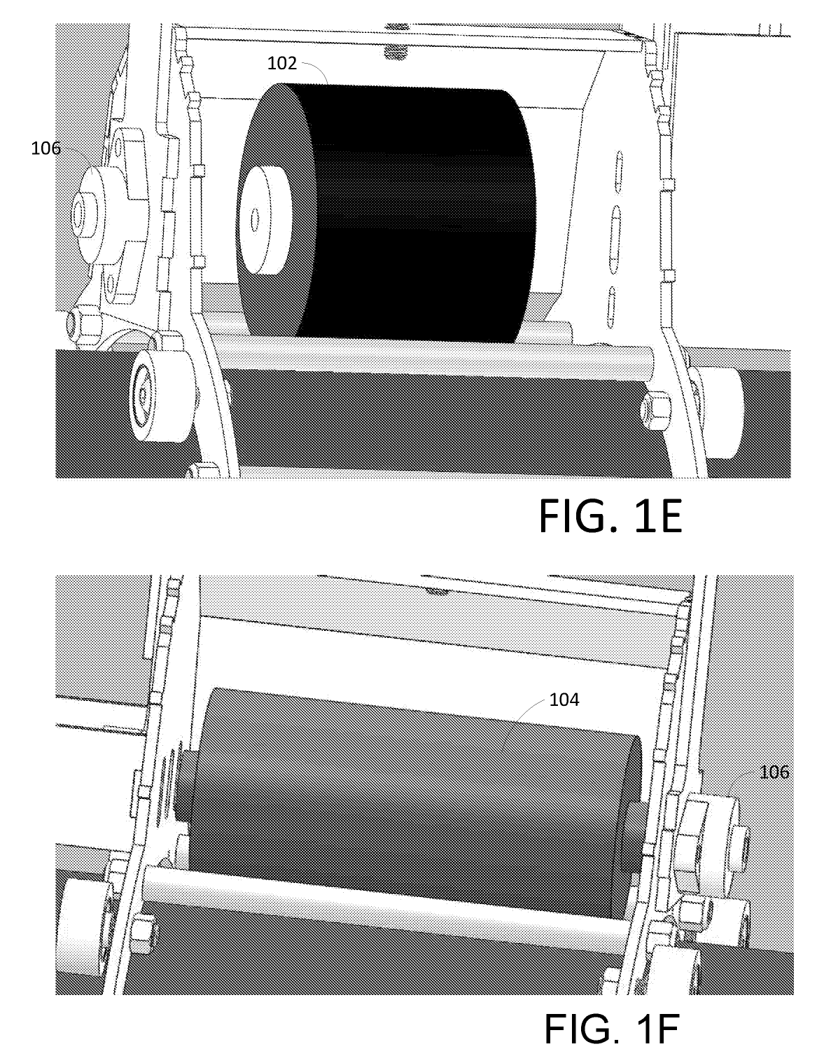

The weld finishing system may utilize a silica free type of blasting and employ a magnetic system to collect all containments that result from blasting the weld. The weld finishing system includes a blaster ring 100 that goes around the pipe and that is fitted to the size of the pipe. FIGS. 1A-1D illustrate an embodiment of a blaster ring 100. The blaster ring 100 may include a cleaner brush 102 and profile brush 104. The cleaner brush 102 is rotatably mounted between a bearing block 106 and brush drive mechanism 108. The profile brush 104 is rotatably mounted between a bearing block 106 and brush drive mechanism 110. Brush motors (not shown) may be attached to the brush drive mechanisms 108 and 110. The motors drive the rotation of the brush during operation. The motors may be of any type that proves sufficient rotation speed and torque on the brushes. For example, an air driven motor driven by compressed air or an electric motor may be used to rotate the brushes. The drive mechanisms 108 and 110 may provide a direct drive connection between the brush motor or a geared connection to allow for a desired range of rotation speeds of the brush. The brushes rotate at high speed and come into contact with the weld to be blasted. The rotating brushes smooth and reduce the weld. The brushes will blast all rust and other containments from the weld that could disrupt the coating. The weld and surrounding area will be blasted down to a profile that is acceptable to any company's blasting standards. Further, a brush case 138 may substantially surround the brush to contain debris brushed off of the pipe 120. A debris magnet (not shown) is included at the base of the brush case 138 next to the pipe 120 to attract and capture the debris loosened by the brushes. The debris magnet may be an electromagnet.

The blaster ring 100 includes a brush adjustment mechanism to adjust the position of the brushes relative to the pipe 120. The brush adjustment mechanism includes a brush adjustment screw 140, brush adjustment handle 112, a stop nut 114, a drive plate 116, and a top plate 118. The top plate 116 is fixed to a blaster ring side 130, and as a result, the top plate 116 maintains a fixed distance from the pipe 120. The drive plate 116 is fixed to the bearing blocks 106 and the brush drive mechanisms 108 and 110 so that as the drive plate moves the brushes 100 and 102. The adjustment screw 140 is threaded through the drive plate 116 and rotatably attached to the top plate 116 so that when the adjustment screw 140 is rotated the top plate 116 moves relative to the drive plate 116, which cause the brushes 102 and 104 to move relative to the pipe 120. The brush adjustment handle 112 is attached to the adjustment screw 140 in order to rotate the adjustment screw 140. Further, the stop nut 114 may be used fix the brush adjustment screw 140 into a desired position. The brush adjustment mechanism allows the brush to be properly positioned relative to the pipe 120 in order to properly clean and profile the pipe 120. As the brushes 102 and 104 wear, the brush adjustment mechanism may be used to move the brush to compensate for the wear on the brushes 102 and 104.

The blaster ring 100 includes various elements to form the ring structure of the blaster ring 100 including the blaster ring tops 128, the blaster ring sides 130, and the ring spacers 132. As can be seen in FIGS. 1A-1D, two rings are formed using a blaster ring top 128 and two blaster ring sides 130. The two rings are then connected to one another using a plurality of ring spacers 132. Further, a lift support 136 may be connected between the two blaster ring tops 128 in the two different rings. The lift support 136 may include a lift opening 142 that may be engaged by a hook to lift and move the blaster ring 100 into position. The blaster ring top 128 is rotatably attached to the two blaster ring sides 132 to allow for rotation between them. This allows for the blaster ring 100 to be opened up and placed around a pipe 120. Other structural configurations of the blaster ring 100 are possible. For example, only two blaster ring sides 132 may be used that are rotatably connected to one another to allow the blaster ring 100 to be opened and placed around the pipe.

The blaster ring 100 includes a plurality of rollers 126 attached to the blaster ring top 128 and blaster ring sides 130. The rollers 126 allow the blaster ring 100 to be rotated about the pipe 120. To further facilitated rotating the blaster ring 100 about the pipe, handles 122 are attached to various points of the blaster ring 100. In FIGS. 1A to 1D four handles 122 are shown, but more or fewer handles 122 may also be used depending upon the size of the blaster ring 100 which is sized based upon the size of the pipe 120 to be blasted. For example, a blaster ring 100 for smaller pipes may only include two or three handles 122, where for larger pipes more than four handles 122 may be used.

When the blasting ring 100 is placed around the pipe 120, latches 124 are engaged to lock and close the blaster ring 100 about the pipe 120. The latches may be of any design that allows for the blaster ring 120 to be securely closed and engaged with the pipe.

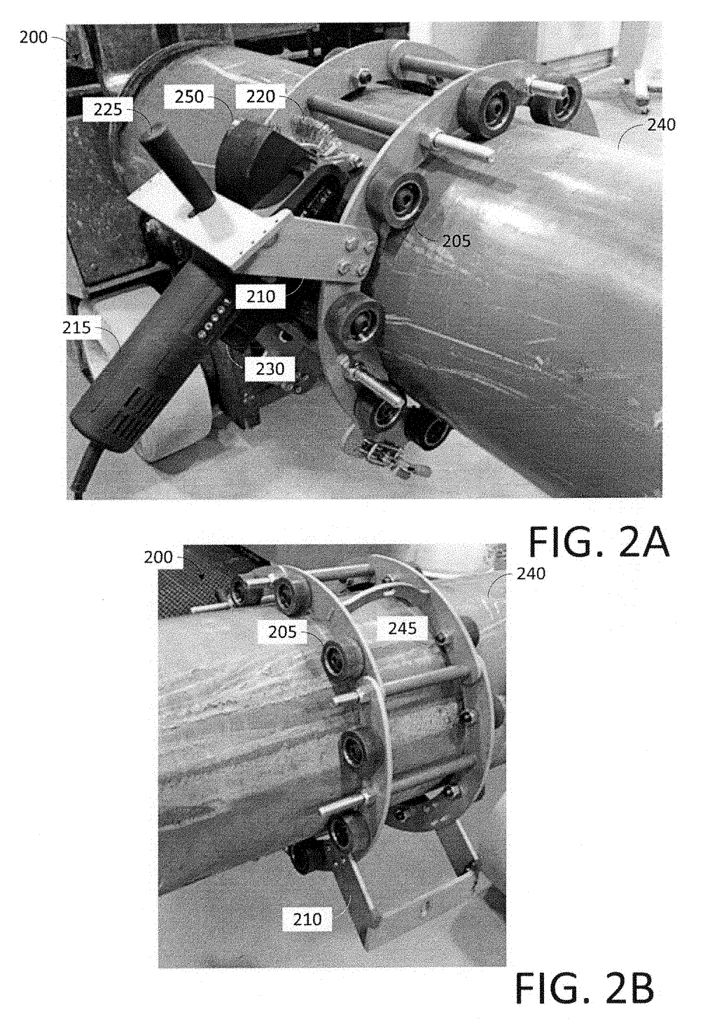

FIGS. 2A-2B illustrate another embodiment of a blaster ring 200. In this embodiment stand-alone bristle blasters 215 may be used, and the bristle blasters 215 may be attached on the outside of the ring 200. The bristle blaster 215 may include bristles 220, a vacuum attachment 250, and a handle 225. The bristles 220 rotate at high speed and come into contact with the weld to be blasted. The rotating bristles 220 smooth and reduce the weld. The bristle blaster will blast all rust and other containments from the weld that could disrupt the coating. The weld and surrounding area will be blasted down to a profile that is acceptable to any company's blasting standards. The handle 225 may be used by a worker to rotate the ring 200 around the pipe 240 to blast the weld. In some embodiments, the handle 225 may also facilitate rotation of the bristle blaster 200 about an axis through the handle 225 to allow a worker to move the rotating bristles laterally across the weld. Also, the handle 225 may be adjustable to adjust the location of the bristle blaster 215 relative to the pipe 240. This allows for the proper amount of force to be applied by the bristles 220 on the pipe 240 and to also adjust the position of the bristle blaster 215 to account for bristle wear.

Further, the vacuum attachment 250 may be attached to the bristle blaster 215 to facilitate the collection of debris from the blasting of the weld. The vacuum attachment 250 may include a vacuum port 230 to which a vacuum system may be attached to capture debris from the blasting operation. The vacuum system will attach at the bottom of the bristle blaster 215. From there, the debris will be sucked through a hose and collected into a wet vacuum tank attached to the back of the machine. The blaster ring 200 may include a blaster mount 210 to which the bristle blaster 215 is mounted.

The blaster ring 200 may also include wheels 205 that are attached to an articulating frame of the blaster ring 200. The wheels 205 engage the pipe 240 and allow the blaster ring 200 and hence the bristle blaster 215 to freely rotate about the pipe 240. As a result, a worker may rotate the blaster ring 200 around the pipe to allow the bristle blaster 215 to blast the entire weld around the pipe 240. Additionally, the ring may also include two or more bristle blasters 215 spread around the circumference of the blaster ring 200 in order to decrease the amount of time needed to blast the weld.

The blaster ring 200 may also include a latching system 235. This allows a worker to place the blaster ring 200 in an open state over the pipe 240, and then to connect the ends of the blaster ring 200 to one another using the latching system 235. The blaster ring 200 may also include a lift support 245 that us used to lift and move the blaster ring 200.

In another embodiment of the blaster ring, a motor may be attached to the blaster ring using a mount. This motor may engage the pipe, for example using wheels, to cause the blaster ring to rotate about pipe to blast the weld. Such a motor may be used to reduce the effort required by a worker to rotate the blaster ring about the pipe. Also, the use of the motor may lead to a more consistent application of bristle blaster to the weld as well as requiring less effort by the workers. Also, in some embodiments a worker may first use the motor to rotate the blaster ring 200 to blast the weld. Then the worker may manually rotate the blaster ring to address areas where the weld is not uniform and requires additional blasting. Multiple mounts may be included on the blaster ring to allow for a hook to lift and move the blaster ring or for multiple motors to be included.

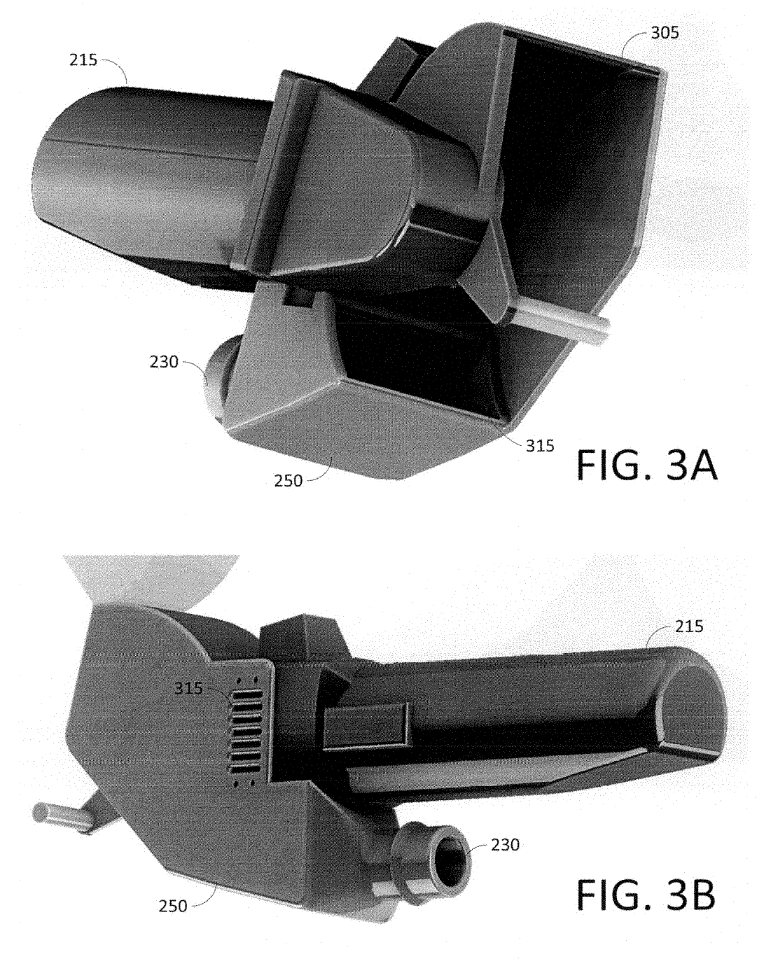

FIGS. 3A-3C illustrate an embodiment of the vacuum attachment 250. The vacuum attachment 250 may include an attachment slot 305 that slides over a portion of the bristle blaster 215 to secure the vacuum attachment 250 to the bristle blaster 215. The vacuum attachment 250 may be further shaped to conform to the bristle blaster 215 to form a seal between the vacuum attachment 250 and the bristle blaster 215. Further, the vacuum attachment 250 may also include other attachment points that engage the bristle blaster 215. Also, the overall shape of the vacuum attachment may be designed to correspond to a specific bristle blaster 215.

The vacuum attachment 250 includes a debris collector 315. The debris collector 315 is adjacent to the brush on the bristle blaster 215 and is configured to collect debris removed from the weld by the bristle blaster 315. The vacuum outlet 230 is attached to the debris collector 315 forming an opening in the debris collector 315 to allow the debris to be removed from the debris collector 315 by a vacuum suction applied to the vacuum outlet 230.

The vacuum attachment 250 may also include vents 310. The vents 310 correspond to vents on the bristle blaster 215 to allow for any venting from the bristle blaster 215. The vents 310 may be adapted to correspond to any vents on the bristle blaster 215.

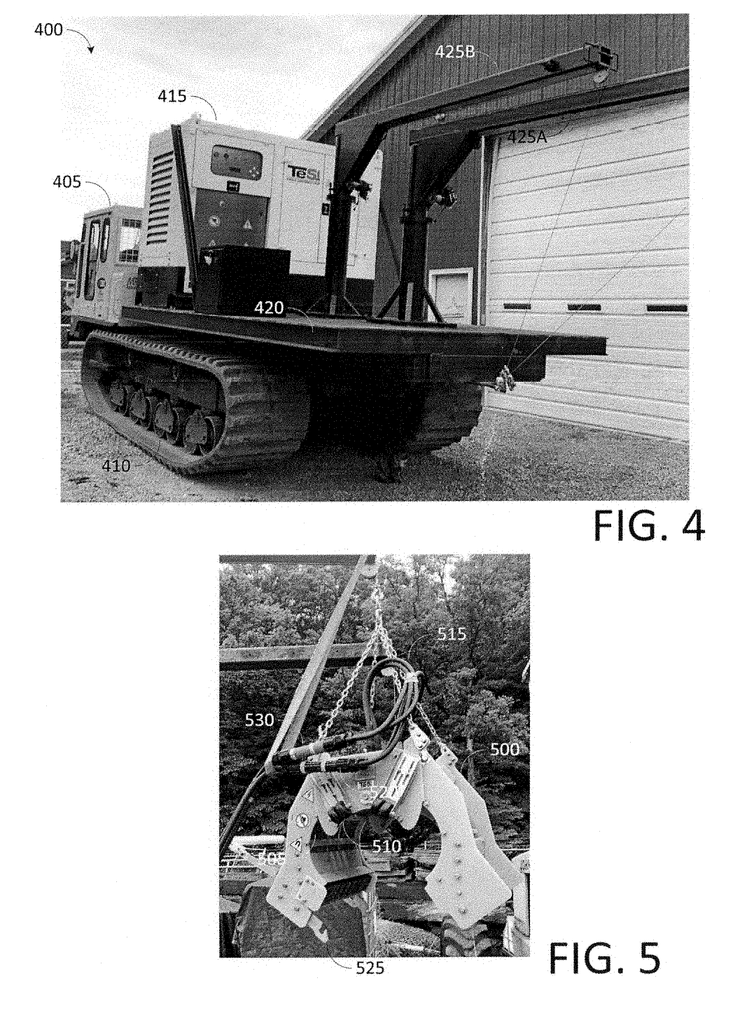

FIG. 4 illustrates a weld finishing vehicle 400. The weld finishing vehicle 400 may include a cab 405, tread 410, generator 415, rear platform 420, first boom 425A, and second boom 425B. The cab 405 houses a driver of the weld finishing vehicle 400. The tread 410 propels the weld finishing vehicle 400 over a wide variety of terrains. In other embodiments, wheels may be used in a configuration that allows for the ability to traverse the terrain where a pipe is being built. The generator 415 provides electrical power to an induction heating ring 430. The rear platform 420 provides a platform to which the first boom 425A and the second boom 425B are mounted. The first boom 425A and the second boom 425B may be used to maneuver a heating ring or a blaster ring onto a pipeline with a weld to be finished. When moving between welds, the rings may be rolled all the way up on the winch line. This will ensure minimal movement side to side. The weld finishing vehicle may also include an air compressor which may be used to power an air-powered motor that drives the brushes.

Now the operation of the blaster ring 100 will be described. A worker may place the blaster ring 100 on the pipe 120 using either the first boom 425A or the second boom 425B. A hook on a cable is attached to the blaster ring for example using the lift support 136. The blaster ring is lowered over the weld using the boom. Another worker may help guide the blaster ring round the pipe as the blaster ring is lowered. One of the workers may then clamp the ring on to the pipe using the latch 124. Next, an air hose or electric power may be attached (if not already attached) to the motors used to rotate the brushes 102 and 104. The cleaning brush 102 cleans the weld and the pipe by removing excess weld material and rust or other contaminants from the pipe. The profile brush profiles the surface of the weld and the pipe 120 to provide a better surface for the application of a coating.

The worker may then move the blaster ring 100 around the pipe manually to blast the weld. The debris magnets facilitates the capture of debris from the blasting operation. This reduces the amount of clean up required after blasting the weld. Periodically the debris captured by the debris magnet may be removed and discarded safely. Once the weld is sufficiently blasted, a worker may unlatch the ring and then remove it from the pipe 120 using the boom and return the blaster ring to the weld finishing vehicle 100 until it is needed for the next weld.

Now the operation of the blaster ring 200 will be described. A worker may place the blaster ring 200 on the pipe using either the first boom 425A or the second boom 425B. A hook on a cable is attached to the blaster ring for example using the lift support 245. The blaster ring 200 is lowered over the weld using the boom. Another worker may help guide the blaster ring 200 around the pipe 240 as the blaster ring is lowered. One of the workers may then clamp the blaster ring 200 on to the pipe 240 using the latching system 235. Next, a worker may attach the vacuum system to the vacuum port 230 (if not already connected) and then power the bristle blaster 215 for the blaster ring 200. The worker may then move the blaster ring around the pipe manually or using the motor (if a motor to rotate the ring is present) to blast the weld. The vacuum attachment 250 facilitates the capture of debris from the blasting operation by the vacuum system. This reduces the amount of clean up required after blasting the weld. Once the weld is sufficiently blasted, a worker may unlatch the ring and then remove it from the pipe 240 using the boom and return the blaster ring to the weld finishing vehicle 100 until it is needed for the next weld.

Depending on the size of the pipe, it is expected that two workers will be able to completely blast and clean the pipe to the correct and acceptable profile within 5 minutes. The advantages of the blaster ring 200 include significant time savings, environmental hazard elimination, increased personnel safety, reduced cleanup, and the complete elimination of sand and silica. Also, because the blasters will be attached to the ring, once the profile is set, they will be able to create a consistent and almost perfect blast profile every single time. With sandblasting, it is almost impossible to get the same blasting pattern and profile every time. In all, the use of the blasting ring will greatly improve efficiency of finishing pipeline welds.

The weld finishing system eliminates the use of an open flame and propane. FIG. 5 illustrates an embodiment of the heating ring 500. The heating ring 500 includes heating coils 505. The heating coils receive electrical power from power cables 515. The power cables 515 include power connectors 520 which are connected to power cables from the generator 415. The heating ring 500 may also include rollers 510 that support the heating ring 500 when it is placed on a pipe. The heating ring 500 may also be split into two portions with a hinge to allow the heating ring 500 to be opened and placed over a pipe. As a result, the heating ring 500 includes locking hooks 525 that are engaged to clamp the heating ring 500 around the pipe during the heating operation. Now the operation of the induction heating ring 500 will be described. Typically, within a minute of blasting, the weld finishing system will use the other boom (i.e., not the boom that moved the blaster ring) to lower down the heating ring 500 so that it surrounds the pipe. Once the induction heating ring 500 is clamped onto the pipe, any size pipe may be heated to specification or 180° F. in a matter of seconds. The induction heating ring 500 can heat up to 500 degrees, but most of the time, users only want to heat the pipe up to 180 degrees. This may include starting the generator 415 to produce the current needed to heat the pipe, but the generator 415 may also be left running between heating operations. Within 15-20 seconds, the pipe will be thoroughly and evenly heated and ready for coating.

The advantages of induction heating are significant. The open torch is completely eliminated as well as all of the hazards associated with operating an open torch, and there is no need for propane to be carried and stored. Further, by not burning propane, there is a reduction in the carbon emissions associated with this step. Next, the time saving is substantial. A 15 to 20 minute process is reduced to a 15 to 20 second heating process and about an additional 2 minutes to attach and remove the ring. Given the way induction heating works, the pipe is heated evenly. With a propane torch, the pipe will be cooled down in locations where the torch was located at the beginning of the heating process leading to an uneven heating profile. By utilizing a generator 415 and induction heating ring 500, the heating process may be greatly improved.

Because, induction heating is completely flame free, this allows induction heating to be used on in-service pipelines as well out of service pipelines without any type of hazard. This eliminates the need for pipelines to be shut down to do repairs. This will save companies a tremendous amount of money in stopped operations. There have been studies done on induction heating, showing that induction heating increases the weld's quality and integrity. Also, with induction heating, the coating will dry faster, because the pipe can be heated to higher temperature and more evenly. This will allow the company to backfill the pipe faster.

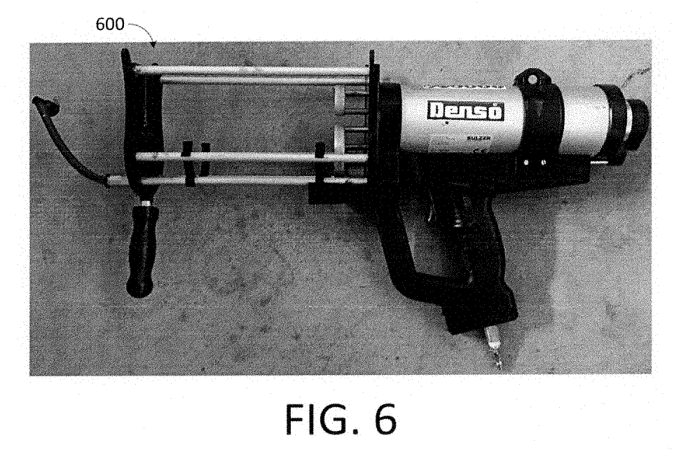

FIG. 6 illustrates an embodiment of a coating gun 600 that may be used in the weld finishing system. The coating gun 600 may use cartridges that contain the coating material, and when the coating gun 650 is used correctly, the coating gun 600 will eliminate the excess paint associated with brushing and rolling. Use of the coating gun is also much quicker than using a paint brush or roller. The coating gun 600 will be on the vehicle and will be attached to an air compressor located on the back of the weld finishing vehicle 400. This coating gun 600 may be used by a worker to spray a coating to the heated weld in the pipe. Using the coating gun 600, two workers may coat the weld in 3 to 5 minutes. Here, the advantages will be the coating gun's 600 ability to not contaminate or overspray the pipe. Because of the design, the coating gun 600 uses less coating material, and the coating material is pre-mixed and ready to spray after it has been heated. Also, with the tip design, the coating gun 600 eliminates the overspray issue. This will lead to saving time and money on coating and cleanup.

In an alternative embodiment, an automatic coating gun may be used. The automatic coating gun may not be mounted on the weld finishing vehicle 400, so that weld finishing vehicle 400 may proceed to blast and heat the next weld, while the workers are coating the previous weld. This will increase the efficiency of the weld finishing process. The automatic coating gun may be attached beside the blaster ring. The coating gun 600 may be on a T at the end of the boom carrying the blaster ring. This will allow the automatic coating gun to be easily interchanged. Also, the automatic coating gun may be mounted on its own boom.

In another embodiment, the blaster ring may be removed from the weld finishing vehicle, and put on another vehicle, which may be sent ahead to start working on the next weld while the current weld is being heated and coated.

Using the weld finishing system and process described herein, four workers will be able to blast, heat, and coat a weld joint on pipeline in approximately 10 to 15 minutes. This will be a significant reduction in the amount of time and workers required for finishing a weld as compared to the traditional method that takes between 8 to 12 workers over an hour to do one weld. Additionally, various environmental concerns will be eliminated by employing the weld finishing system and process described herein. Further, the pipeline's weld quality and integrity will be significantly improved, because of the greatly improved and consistent blasting profile, the even and thorough heating, and the use of an advanced coating gun. Also, because of the use of induction heating, repairs may be made to the pipeline while the pipeline is in service.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications can be affected while remaining within the spirit and scope of the invention. Accordingly, the foregoing disclosure, description, and figures are for illustrative purposes only and do not in any way limit the invention, which is defined only by the claims.

What is claimed is:

1. A blasting ring for blasting a weld on a pipe, comprising:
a ring structure with a first pivot point and a latch, wherein the first pivot point allows the ring structure to open and close around the pipe and the latch is configured to secure the ring to the pipe;
a plurality of rollers attached to the ring structure configured to engage the pipe;
a cleaner brush attached to the ring structure configured to rotate and engage the weld on the pipe to clean the weld; and
a profile brush attached to the ring structure configured to rotate and engage the weld on the pipe to profile the weld.

2. The blaster ring of claim 1, further comprising:
a first motor coupled to the cleaner brush configured to rotate the cleaner brush; and
a second motor coupled to the profile brush configured to rotate the profile brush.

3. The blaster ring of claim 2, wherein the first motor and the second motor are air-powered motors.

4. The blaster ring of claim 2, further comprising:
a first brush drive mechanism between the first motor and the cleaner bush; and
a second brush drive mechanism between the second motor and the profile bush.

5. The blaster ring of claim 1, further comprising a brush adjustment mechanism configured to adjust the position of one the cleaner bush and profile brush relative to the pipe.

6. The blaster ring of claim 1, further comprising a debris magnet configured to capture debris produced by one of the cleaner brush or the profile brush.

7. The blaster ring of claim 6, further comprising a brush case substantially surrounding one of the cleaner brush or the profile brush configured to contain debris produced by one of the cleaner brush or the profile brush

8. The blaster ring of claim 1, further comprising a plurality of handles attached to the ring structure configured to rotate the ring blaster about the pipe when a force is applied to one of the plurality of handles.

9. The blaster ring of claim 1, further comprising a lift support attached to the ring structure.

10. The blaster ring of claim 1, wherein the ring structure further comprises a second pivot point, wherein the second pivot point allows the ring structure to open and close around the pipe.

11. A method of finishing a weld on a pipe, comprising:
placing a ring blaster ring around a pipe;
rotating the ring blaster ring around the pipe while rotating a cleaner brush and profile brush;
removing the ring blaster ring from around the pipe;
placing a heating coil around the pipe;
heating the pipe with the heating coil;
removing the heating coil from around the pipe; and
coating the heated pipe.

12. The method of claim 11, further comprising adjusting the position of one of the cleaner brush and the profile brush relative to the pipe.

13. The method of claim 11 further comprising removing debris from a debris magnet after removing the ring blaster from around the pipe.

14. The method of claim 11, further comprising latching the ring blaster closed after placing the ring blaster around the pipe.

15. The method of claim 14, further comprising latching the heating ring closed after placing the heating ring around the pipe.

16. The method of claim 11, wherein the ring blaster comprises:
a ring structure with a first pivot point and a latch, wherein the first pivot point allows the ring structure to open and close around the pipe and the latch is configured to secure the ring to the pipe;
a plurality of rollers attached to the ring structure configured to engage the pipe;
a cleaner brush attached to the ring structure configured to rotate and engage the weld on the pipe to clean the weld; and
a profile brush attached to the ring structure configured to rotate and engage the weld on the pipe to profile the weld.

17. The method of claim 16, wherein the ring blaster further comprises:
a first motor coupled to the cleaner brush configured to rotate the cleaner brush; and
a second motor coupled to the profile brush configured to rotate the profile brush.

18. The method of claim 17, wherein the first motor and the second motor are air-powered motors.

19. The method of claim 18, further comprising attaching an air hose to the air-powered motors.

20. The method of claim 18, further comprising supplying air to the air-powered motors.
